(19) United States
(12) Patent Application Publication
(10) Pub. No.: US 2009/0290147 A1
(43) Pub. Date: Nov. 26, 2009

(54) DYNAMIC POLARIZATION BASED FIBER OPTIC SENSOR

(75) Inventors: Trevor Wayne MacDougall, Simsbury, CT (US); Paul Eric Sanders, Madison, CT (US)

Correspondence Address: MCCORMICK, PAULDING & HUBER LLP, CITY PLACE II, 185 ASYLUM STREET, HARTFORD, CT, 06103, US

(73) Assignee: QOREX LLC, Hartford, CT (US)

(21) Appl. No.: 12/124,517

(22) Filed: May 21, 2008

(51) Int. Cl. G01N 21/00; G01J 4/00; G01B 9/02

(52) U.S. Cl. 356/73; 356/369; 356/366; 356/477

(57) ABSTRACT

An optical fiber sensor system includes an optical fiber. A linear polarizing component is configured to communicate with the optical fiber. The linear polarizing component includes a polarization sensing fiber to be disposed adjacent to and preferably collinear with the optical fiber. A light source communicates with the linear polarizing component for generating a light signal along the optical fiber. A reflector is disposed along the optical fiber for reflecting back the light signal along the optical fiber. An optical detector communicates with the linear polarizing component. A signal processor communicating with the optical detector and configured for determining from the reflected light signal dynamic events along the optical fiber.

### FIELD OF THE INVENTION

The present invention is directed generally to optical fiber sensors, and more particularly to dynamic polarization based optical fiber sensors for detecting dynamic events acting on optical fibers.

### BACKGROUND OF THE INVENTION

The present invention involves a proposed solution to address some of the shortcomings and complexity experienced with fiber sensing techniques applied to respond to dynamic events acting on an optical fiber. Dynamic sensing is used to track and measure events with some frequency or time-resolved component—typically above 20 Hz-30 Hz, such as vibration, acoustic, rotation rate, pressure, temperature, magnetic field, or other physical parameter that alters light propagation in an optical fiber. These changes are tracked over time and processed to provide a measurement of some parameter acting on a length of fiber assembled in a sensor transducer. Typically this measurement is performed using phase sensitive optical interferometers which, although highly sensitive, are difficult to construct and involve complex and expensive signal detection and processing equipment and software. This limits the cost effectiveness of the interferometric approach to address a number of applications beyond ones that can justify a high cost per sensing point.

Solutions to the above-mentioned problems include dynamic fiber optic sensors which include intensity-modulated sensors that measure power changes in a fiber under stress such as in vibration monitoring, or light scatter intensity in a medium such as in a gas flow meter. Such sensors also include some highly specialized spectrally or wavelength-modulated sensors using extrinsic Fabry-Perot devices of fiber Bragg gratings configured to respond to dynamic events. These sensors have been demonstrated in laboratory and some low volume niche applications; however the bulk of commercially successful dynamic sensors are interferometric based which leverage the sensitivity achievable with the technology in a number of relatively high performance applications.

These sensors are constructed among a number of classical interferometer configurations such as Fabry-Perot, Mach Zehnder, and Michelson typically used in commercial acoustic, flow, and seismic sensing; and Sagnac in inertial and magnetic field sensing. There are also some emerging interferometric-based intrusion detection systems used in asset and facility security systems that use a range of configurations.

Interferometric sensors measure slight dynamic fiber path-length changes that result in phase change of light propagating down the sensing fiber. These changes are detected as an intensity signature of frequency peaks or fringes that are processed electronically and interpreted as path length changes over time. This is then correlated to the magnitude of the measurand over time. In some cases, multiple interferometric sensors are arranged in an array of sensors to track speed of an event as in the case of acoustic wave velocity in seismic sensing, or velocity of pressure disturbances in flow meters. To resolve these measurements requires complex optical interrogation equipment, including expensive modulation and receiver modules, and relatively complex processing electronics and software. The high cost of this interrogation is compounded in multi-point sensing such as acoustic systems (seismic) in which sensor interrogation equipment becomes unwieldy and prohibitively expensive in all but the most critical applications. In addition the construction of the transducer and sensing fiber packaging becomes quite demanding in the precision of fiber lengths and fiber mounting or coil winding which becomes a significant cost component of the system.

There is an ongoing need for a simpler and more inexpensive approach to accurately detecting dynamic events occurring along an optical fiber.

### SUMMARY OF THE INVENTION

In accordance with the present invention, an optical fiber sensor system to detect dynamic events includes a single mode optical fiber which serves as the sensing element. The fiber single mode propagation is due to the small size of the fiber core in which by design only a limited number of wavelengths will transmit above the specified fiber operating wavelength. Single mode fiber however supports two subsequent polarization modes or eigenmodes, which in a perfectly circularly symmetric fiber are degenerate with identical propagation velocity. In practical application however, slight fiber imperfections and external perturbations acting on the fiber will break the degeneracy, creating a difference in propagation velocity between the polarization modes, so that the fiber becomes birefringent. The polarization state of light launched into the fiber will transform slightly because of slight intrinsic waveguide imperfections, a result of the fiber manufacturing process. This polarization state will be further transformed due to external perturbations or stresses acting on the fiber that couple power between the polarization modes. Besides the inevitable mechanical bending encountered when installing or packaging the fiber, most external stresses are dynamic due to changing environments from a range of thermal, mechanical, vibrational, acoustic, and magnetic effects of which fiber polarization and birefringence can be quite sensitive. Detecting these dynamics events according to this invention is accomplished by configuring a linear polarizing component in communication with the sensing optical fiber. The linear polarizing component includes a polarization sensing fiber to be disposed adjacent to—preferably collinear with—the optical fiber. A light source communicates with the linear polarizing component for generating a light signal along the optical fiber. A reflector is disposed along the optical fiber for reflecting the light signal along the optical fiber. An optical detector communicates with the linear polarizing component. A signal processor communicates with the optical detector and is configured for determining from the reflected light signal dynamic events along the optical fiber.

### BRIEF DESCRIPTION OF THE DRAWINGS

FIG. 1 schematically illustrates an optical fiber sensor system embodying the present invention.

FIG. 2 schematically illustrates an optical fiber sensor system including fiber Bragg grating reflectors in accordance with another embodiment of the present invention.

FIG. 3 are graphs illustrating the optical signal and processed signal properties of an optical fiber sensor system in accordance with the present invention.

FIG. 4 schematically illustrates an optical fiber sensor system employing a wavelength division multiplexing (WDM) configuration.

FIG. 5 schematically illustrates the component differences between a conventional interferometric optical fiber sensor system and a polarization optical fiber sensor system in accordance with the present invention.

FIG. 6 is a table illustrating precision tolerance differences between an interferometric optical fiber sensor system and a polarization optical fiber sensor system.

### DETAILED DESCRIPTION OF THE PREFERRED EMBODIMENTS

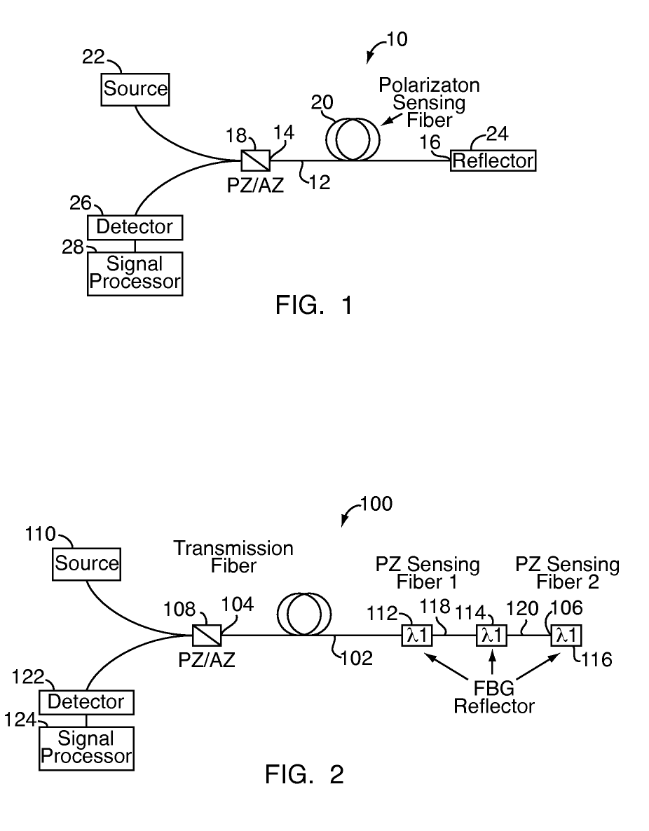

With reference to FIG. 1, an optical fiber sensor system embodying the present invention is indicated generally by the reference number 10. The system 10 includes a waveguide such as an optical fiber 12 having a first longitudinal end 14 and a second longitudinal end 16. A linear polarizing component is configured to communicate with the optical fiber 12. The linear polarizing component includes a polarizer/analyzer circuit 18 coupled to the first longitudinal end 14 of the optical fiber 12, and includes a polarization sensing fiber 20 to be disposed along and adjacent to, and preferably collinear with, the optical fiber. A light source 22 communicates with the polarizer/analyzer circuit 18 for generating a light signal along the optical fiber 12. A reflector 24 is disposed adjacent to the second longitudinal end 16 along the optical fiber 12 for reflecting back the light signal along the optical fiber. An optical detector 26 communicates with the polarizer/analyzer circuit 18 for sensing the reflected light signal. A signal processor 28 communicates with the optical detector 26 for processing information extracted from the reflected light signal.

The system 10 directly measures any perturbation imparted onto the structure of the optical fiber 12 which causes a modulation of the birefringence of the waveguide or creates an exchange of the light energy from one orthogonal propagating mode to the other (cross coupling). These perturbations can be the result of, for example, pressure disturbances, vibration, temperature, or acoustic waves.

The optical system 10 can be mathematically modeled using Jones calculus matrices as follows:

$$( \begin{matrix}eox \\ eoy\end{matrix} ) = ( \begin{matrix}1 & 0 \\ 0 & 0\end{matrix} ) ( \begin{matrix}cos ( θ ) & - sin ( θ ) \\ sin ( θ ) & cos ( θ )\end{matrix} ) ( \begin{matrix}exp ( g ( t ) j ) & 0 \\ 0 & exp ( - g ( t ) j )\end{matrix} ) ( \begin{matrix}cos ( θ ) & sin ( θ ) \\ - sin ( θ ) & cos ( θ )\end{matrix} ) ( \begin{matrix}1 & 0 \\ 0 & 0\end{matrix} ) ( \begin{matrix}einx \\ einy\end{matrix} )$$

Where eox,y represent the output light vectors and einx,y represent the input light vectors. The function g(t) is the signal modulating the birefringence of the sensing waveguide. The objective of the signal processing system is to reproduce the function g(t) electronically with very high spectral fidelity so that application specific analysis can be completed. The architecture shown in FIG. 1 provides a signal which is influenced by the entire section of polarization sensitive fiber as shown.

With reference to FIG. 2, an optical fiber sensor system in accordance with another embodiment of the present invention is indicated generally by the reference number 100. The system 100 includes a waveguide such as an optical fiber 102 having a first longitudinal end 104 and a second longitudinal end 106. A linear polarizing component is configured to communicate with the optical fiber 102. The linear polarizing component includes a polarizer/analyzer circuit 108 coupled to the first longitudinal end 104 of the optical fiber 102. A light source 110 communicates with the polarizer/analyzer circuit 108 for generating a light signal along the optical fiber 102. A plurality of fiber Bragg grating (FBG) reflectors 112, 114, 116 are spaced along the optical fiber 102. As shown in FIG. 2 by way of example, three fiber Bragg grating reflectors 112, 114, 116 are spaced along the optical fiber 102 adjacent to the second longitudinal end 106 such that a portion of the optical fiber between the first fiber Bragg grating reflector 112 and the second fiber Bragg grating reflector 114 serves as a first polarization sensing fiber 118, and a portion of the optical fiber between the second fiber Bragg grating reflector 114 and the third fiber Bragg grating reflector 116 serves as a second polarization sensing fiber 120. Although three fiber Bragg grating reflectors are shown by way of example, a fewer or greater number of fiber Bragg grating reflectors can be implemented without departing from the scope of the present invention.

An optical detector 122 communicates with the polarizer/analyzer circuit 108 for sensing the reflected light signal. A signal processor 124 communicates with the optical detector 122 for processing information extracted from the reflected light signal. The system 100 is configured to allow multiple sections of the same optical fiber to function as stand alone sensors providing an array type feature.

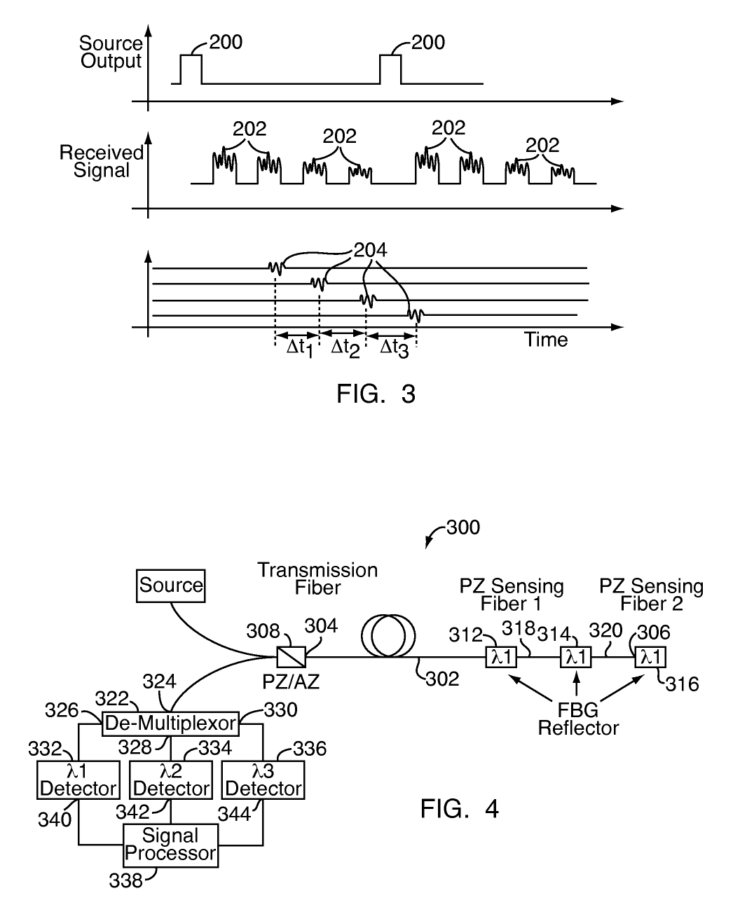

The fiber Bragg grating (FBG) reflectors 112, 114, 116 are configured to reflect the same wavelength slot of the source light. In this case it is necessary to process the signals in the time domain which can be performed in conjunction with pulsing of the light source 110. Using a pulsed system with the timing characteristics shown in FIG. 3, a time division multiplexing (TDM) based system is realized to allow the interrogation of an array of these dynamic polarization sensors. By processing the return optical signal the evolution of a disturbance from one sensor to the other can be tracked and used to calculate signature events along the length of the optical fiber 102.

With reference to FIGS. 2 and 3, the light source 110 generates pulsed signals 200 which are introduced into the optical fiber 102. For each of the pulsed signals 200, the detector 122 receives a plurality of reflected light signals 202 from the plurality of fiber Bragg grating reflectors 112, 114, 116. The signal processor 124 processes the reflected light signals into processed signals 204 to determine disturbances along the optical fiber 102.

The pulse width, and duty cycle of the light source 110 is chosen to coincide with the length of the sensor to enable the deconvolution of each sensor cell. In an alternative configuration a wavelength division multiplexing (WDM) system can be employed to also allow the analysis of each sensing cell independently. This requires using FBGs with different wavelengths, but alleviates the length restriction of the sensor as well as avoidance of any pulsing electronics in the source and signal processor. A WDM demultiplexer is preferably incorporated into a receiver unit so that each section as defined by wavelength of the corresponding FBG is individually processed. A WDM configuration is shown by way of example in FIG. 4.

Turning to FIG. 4, an optical fiber sensor system implementing a WDM configuration is indicated generally by the reference number 300. The system 300 includes a waveguide such as an optical fiber 302 having a first longitudinal end 304 and a second longitudinal end 306. A linear polarizing component is configured to communicate with the optical fiber 302. The linear polarizing component includes a polarizer/analyzer circuit 308 coupled to the first longitudinal end 304 of the optical fiber 302. A light source 310 communicates with the polarizer/analyzer circuit 308 for generating a light signal along the optical fiber 302. A plurality of fiber Bragg grating reflectors 312, 314, 316 are spaced along the optical fiber 302. As shown in FIG. 4 by way of example, three fiber Bragg grating reflectors 312, 314, 316 are spaced along the optical fiber 302 adjacent to the second longitudinal end 306 such that a portion of the optical fiber 302 between the first fiber Bragg grating reflector 312 and the second fiber Bragg grating reflector 314 serves as a first polarization sensing fiber 318, and a portion of the optical fiber 302 between the second fiber Bragg grating reflector 314 and the third fiber Bragg grating reflector 316 serves as a second polarization sensing fiber 320. Although three fiber Bragg grating reflectors are shown by way of example, a fewer or greater number of fiber Bragg grating reflectors can be implemented.

A WDM demultiplexer 322 includes an input 324 coupled to the polarizer/analyzer circuit 308, and includes three outputs 326, 328, 330 each coupled to a corresponding one of three optical detectors 332, 334, 336. A signal processor 338 communicates with the optical detectors 332, 334, 336 via respective outputs 340, 342, 344 of the optical detectors for processing information extracted from the reflected light signal.

Slow drifts of the polarization state of the optical signal are very commonplace in standard (Non PM) fibers and are difficult to detect. However, the detection of AC type signals and especially the comparison of these signals from separate portions of the optical fiber over a very short period avoids the need for any absolute calibration. Any slow drift component is essentially the same to all of the sensors and can be eliminated easily using any common-mode rejection algorithm.

The use of a polarization based optical sensor in accordance with the present invention can be used to directly measure very minute perturbations applied to a sensing fiber section. Typically this measurement has been performed using phase sensitive optical interferometers. This method requires complicated processing and pulsing electronics as well as ultra precise location of sensing fiber lengths. Both of these issues limit the cost effectiveness of the interferometric approach from both a hardware/software complexity and manufacturing/test perspective. The polarization architectures presented in the present application are relatively simple to manufacture and require low cost signal processing electronics. In addition the light source required for the polarization sensor can be a broad band low coherence source as compared to the more complex laser sources needed for the interferometric architectures. The sensitivity of the polarization based optical sensor can be enhanced by the use of special fiber waveguide designs such as operation at or near second mode cutoff wavelength (high V value) and low-birefringence twisted or spun fiber, and fiber coatings that impart sensitivity or improved coupling to the measurand such as high modulus (preferably about Shore D 70 or higher) polymers for acoustic sensing.

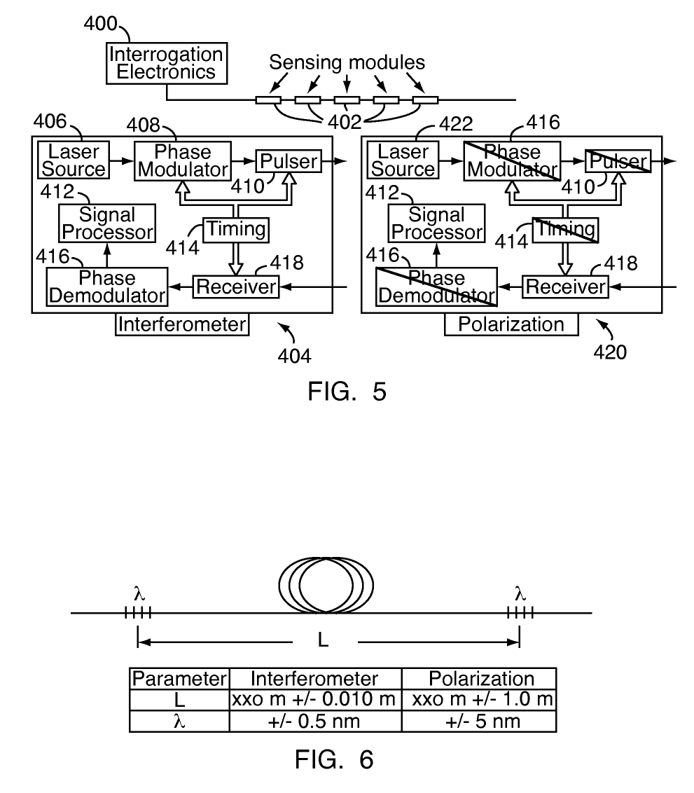

FIGS. 5 and 6 show the major component differences between the interferometric approach and the approach of the present invention. As shown in FIG. 5, both systems include interrogation electronics 400 and sensing modules 402. An interferometer system 404 further requires complex and expensive equipment including a laser source 406, a phase modulator 408, a pulser 410, a signal processor 412, a timing circuit 414, a phase demodulator 416 and a receiver 418. A polarization system 420 embodying the present invention does not require (as denoted by slash lines) a phase modulator 416, a pulser 410, a timing circuit 414 or a phase demodulator 416. Moreover, a light source 422 of the polarization system 420, as mentioned above, can be a broad band low coherence source as opposed to the more complex and expensive laser source 406 required for the interferometer system 404.

FIG. 6 is a table illustrating the required precision tolerance differences between a conventional interferometric approach and a polarization approach in accordance with the present invention. More specifically, the table illustrates that the required precision tolerance for length L of a sensing fiber section is significantly higher (about 100 fold) for the interferometric approach as compared to the polarization approach. Further, the table illustrates that the required wavelength precision tolerance is higher (about 10 fold) for the interferometric approach as compared to the polarization approach. The reduced required precision tolerances of the polarization approach results in a simpler and more cost effective approach to detecting dynamic events along an optical fiber.

Although the invention has been described and illustrated with respect to exemplary embodiments thereof, the foregoing and various other additions and omissions may be made therein and thereto without departing from the spirit and scope of the present invention.

What is claimed is:

1. An optical fiber sensor system comprising:
an optical fiber;
a linear polarizing component configured to communicate with the optical fiber, the linear polarizing component including a polarization sensing fiber to be disposed adjacent to the optical fiber;
a light source communicating with the linear polarizing component for generating a light signal along the optical fiber;
a reflector disposed along the optical fiber for reflecting back the light signal along the optical fiber;
an optical detector communicating with the linear polarizing component; and
a signal processor communicating with the optical detector and configured for determining from reflected light signals dynamic events along the optical fiber.

2. An optical fiber sensor system as defined in claim 1, wherein the linear polarizing component includes a polarizer/analyzer circuit.

3. An optical fiber sensor system as defined in claim 1, wherein the reflector includes a plurality of fiber Bragg grating reflectors spaced along the optical fiber.

4. An optical fiber sensor system as defined in claim 1, wherein the reflector includes three fiber Bragg grating reflectors spaced along the optical fiber.

5. An optical fiber sensor system as defined in claim 3, wherein the light source is configured for generating a light signal having a pulse width and duty cycle coinciding with a length of associated sensor fiber portions disposed between the fiber Bragg grating reflectors.

6. An optical fiber sensor system as defined in claim 5, wherein the signal processor is configured for analyzing reflected light signals using time division multiplexing.

7. An optical fiber sensor system as defined in claim 3, wherein the optical detector includes a plurality of detectors each associated with a corresponding one of the fiber Bragg grating reflectors, the fiber Bragg grating reflectors having different wavelengths relative to each other, and further comprising a wavelength division multiplexing demultiplexer having an input coupled to the linear polarizing component and a plurality of outputs each coupled to a corresponding one of the plurality of detectors.

8. An optical fiber sensor system as defined in claim 4, wherein the optical detector includes three detectors each associated with a corresponding one of the three fiber Bragg grating reflectors, the fiber Bragg grating reflectors having different wavelengths relative to each other, and further comprising a wavelength division multiplexing demultiplexer having an input coupled to the linear polarizing component and three outputs each coupled to a corresponding one of the three detectors.

9. An optical fiber sensor system as defined in claim 1, wherein the signal processor is configured to control propagation of the light signal along the optical fiber in accordance with the following mathematical model using Jones calculus matrices:
$$( \begin{matrix}eox \\ eoy\end{matrix} ) = ( \begin{matrix}1 & 0 \\ 0 & 0\end{matrix} ) ( \begin{matrix}cos ( θ ) & - sin ( θ ) \\ sin ( θ ) & cos ( θ )\end{matrix} ) ( \begin{matrix}exp ( g ( t ) j ) & 0 \\ 0 & exp ( - g ( t ) j )\end{matrix} ) ( \begin{matrix}cos ( θ ) & sin ( θ ) \\ - sin ( θ ) & cos ( θ )\end{matrix} ) ( \begin{matrix}1 & 0 \\ 0 & 0\end{matrix} ) ( \begin{matrix}einx \\ einy\end{matrix} )$$
where eox and eoy represent output light vectors;
where einx and einy represent input light vectors; and
g(t) is the signal modulating birefringence along the optical fiber.

10. An optical fiber sensor system as defined in claim 1, wherein the light source is a broad band low coherence source.

11. An optical fiber sensor system as defined in claim 1, wherein the optical fiber is configured to operate at or near second mode cutoff wavelength.

12. An optical fiber sensor system as defined in claim 1, wherein the optical fiber is twisted or spun to impart low intrinsic birefringence.

13. An optical fiber sensor system as defined in claim 1, wherein the optical fiber is coated with a high modulus polymer.

14. An optical fiber sensor system as defined in claim 13, wherein the high modulus is about Shore D 70 or higher.

15. An optical fiber sensor system as defined in claim 1, wherein the polarizing sensing fiber is disposed collinear with the optical fiber.
